(19) United States
(12) Patent Application Publication
(10) Pub. No.: US 2020/0178553 A1
(43) Pub. Date: Jun. 11, 2020

(54) ALTERNATIVE FREEZING METHODS FOR LIQUID FROZEN CONTENTS

(71) Applicant: Meltz, LLC, Bedford, MA (US)

(72) Inventors: Matthew P. ROBERTS, South Boston, MA (US); Douglas Martin HOON, Guilford, CT (US); Karl WINKLER, Bedford, MA (US)

(21) Appl. No.: 16/615,753

(22) PCT Filed: May 30, 2018
(86) PCT No.: PCT/US2018/035073

§ 371 Date: Nov. 21, 2019

Related U.S. Application Data
(60) Provisional application No. 62/534,829, filed on Jul. 20, 2017.
(60) Provisional application No. 62/512,440, filed on May 30, 2017.

(51) Int. Cl. A23F 5/38; B65D 85/804; A23G 9/04

(52) U.S. Cl. CPC A23F 5/385; A23G 9/045; B65D 85/8046

(57) ABSTRACT

Methods are described for creating shapes for the frozen liquid contents stored within single-serve pods used in dispensing machines for products such as coffee. Shapes may include freezing a liquid held statically in the pod in various orientations. Methods may include freeze/thaw/refreeze strategies, freezing the liquid while the pod is spinning or tumbling, use of preforms from molds, preforms made with probes, and/or use of preforms that have been formed by extrusion or pressing. In some embodiments, a shape is produced that does not interfere with the entrance of entrance or exit needles projected into the pod by the dispenser and shapes that do not interfere with the flow of a melting/diluting liquid during its transit from entrance to exit needle.

### RELATED APPLICATIONS

This application relates to and claims priority under 35 U.S.C. § 119(e) to U.S. Provisional Patent Application No. 62/512,440, entitled “Alternate Freezing Methods for Liquid Frozen Contents,” filed on 30 May 2017, and U.S. Provisional Patent Application No. 62/534829, entitled “Alternate Freezing Methods for Liquid Frozen Contents,” filed on 20 Jul. 2017, all of which are incorporated by reference herein in their entirety.

### TECHNICAL FIELD

The technical field relates generally to a method of and system for freezing a consumable liquid food or beverage product inside of a single-serve pod intended for use in a beverage dispenser such that a clear pathway is established around the frozen contents and between an entrance needle and an exit needle of the dispenser when these needles are penetrated into the pod and a melting/diluting fluid is introduced.

### BACKGROUND

The concept of filling or partially filling a receptacle suitable for insertion into a coffee brewer or dispenser with the receptacle containing a concentrated liquid extract of coffee, tea, juice, or various other beverages and then freezing the contents to capture and preserve flavor has been disclosed in several previously issued patents and pending applications, for example U.S. Pat. No. 9,346,611 titled “Apparatus and Processes for Creating a Consumable Liquid Food or Beverage Product From Frozen Contents,” issued May 24, 2016, which is incorporated by reference herein. Additionally, U.S. Pat. No. 9,675,203 titled “Methods of Controlled Heating and Agitation for Liquid Food or Beverage Product Creation,” issued Jun. 13, 2017, is incorporated by reference herein.

For the purposes of this document, the container used to house the concentrated extract may variously be called a “container”, a “cup”, a “pod”, or a “receptacle”. This container may be of any arbitrary shape, but generally comprises:
a sidewall extending from a first end of the receptacle to a second end of the receptacle, at least a portion of the sidewall being tapered;
a continuous end layer disposed at the first end of the receptacle, the continuous end layer transitioning from the sidewall at a boundary between the sidewall and the continuous end layer, the boundary encompassing the continuous end layer, the continuous end layer lacking openings within the continuous end layer encompassed by the boundary, and the continuous end layer defining an unbroken inner surface and a corresponding unbroken outer surface;
a closure disposed at the second end of the receptacle; wherein
the sidewall, the continuous end layer, and the closure define a sealed cavity of the receptacle.

While the container may be of any arbitrary shape, a shape of particular interest is one which is dimensionally compatible with brewers manufactured by KEURIG®. Such a container is approximately 1.75″ in height, has a closed bottom end diameter of approximately 1.45″, an open end inside diameter of about 1.55″, and a top weldable flange outside diameter of about 2.0″. For ease of description hereinafter, this KEURIG® compatible cup is referred to as a “K-cup like receptacle.”

Also, for the purposes of this document, the closure disposed at the second end may be called a “lid” and the liquid frozen contents, of whatever shape, may be generically called a “slug.”

Known techniques for forming and freezing the liquid extract include pouring a measured amount of extract into an upwardly facing opening of the receptacle, attaching a weldable lid to the flange of the receptacle, and then flash freezing the contents using, for example, a bath of liquid nitrogen. This results in a symmetrical slug of extract in the bottom of a K-cup like receptacle with a flattened upper surface, conforming to the inner walls of the receptacle. In practice, the height of this slug may vary from about 3/8″ to about 1.5″.

For these pods to function properly when used in one of the various models of the targeted coffee brewers, it is necessary to establish a flow path for the liquid pumped through the top entrance needle of the brewer to the bottom exit needle of the brewer. In many existing brewers, the top needle is aligned with the central symmetric axis of the pod and the bottom needle is located near the outer periphery of the pod bottom. Both needles are aligned vertically and simultaneously penetrate the pod when the brewer cover is closed. If such a flow path is not created, an over-pressure condition or a clogging of the entrance needle is created and sensed by the brewer, at which point the cycle is terminated. U.S. Pat. No. 9,630,770, incorporated by reference herein, describes a pod wherein a frozen content is positioned within a tapered wall receptacle to be dislodged on puncture to create a flow path. As taught by U.S. Pat. No. 9,630,770, the bottom needle may break the frozen slug of extract free from the bottom surface and lifts it inside the pod such that water can flow around its sides via a gap created by the tapered side walls and then flow across the bottom of the pod. Occasional problems have been observed with this technique. For example, dislodging the frozen contents upon puncture can create unwanted stresses on the machine while closing the dispenser cover.

Therefore, other filling/freezing methods are desired to reduce unwanted stresses on the dispenser while closing the cover and puncturing the pod as well as significantly reducing the chance of an over-pressure condition without negative impact on the melting/dilution of the liquid frozen contents, e.g., a method which ensures an unobstructed flow path from entrance needle to exit needle while still creating sufficient interaction between the hot liquid and the surfaces of the frozen contents.

### SUMMARY

The techniques and methods described herein create configurations for the frozen contents within the pods other than what would be achieved by simply freezing the liquid as it rests in a pod with the pod oriented such that its base lies flat on a horizontal surface with the opening pointed upward.

In some embodiments, the methods contemplate freezing the frozen extract with a specific configuration, sealing the pod, and then using thaw and refreeze techniques to relocate the frozen extract inside a pod with a specific new position, and storing the pod in a specific position while it refreezes. The methods include freeze/thaw/refreeze steps and use of preformed frozen solids.

In some embodiments, a method is used for creating a shape for liquid frozen contents in a single-serve pod wherein the shape does not interfere with the penetration of entrance and exit needles into the pod and a flow path for a melting and diluting liquid is established.

In some embodiments, the shape of the liquid frozen contents is formed by freezing the liquid while the pod is resting on its side.

In some embodiments, the liquid frozen content is frozen outside the pod and then placed inside the pod.

In some embodiments, the shape of the liquid frozen contents is formed by freezing the liquid while the pod is held at a preferred angle, melting an interface between the contents and the pod wall, allowing the contents to move to a desired position, and refreezing the interface between the contents and the pod.

In some embodiments, the liquid content is frozen into a specific shape, partially thawed to ease removal from a mold, placed into a pod at a specific angle or orientation, and then refrozen.

In some embodiments, the shape of the liquid frozen contents is formed by freezing the liquid while the pod is rotating about its central axis.

In some embodiments, the shape of the liquid frozen contents is formed by freezing the liquid while the pod is randomly tumbling or shaking.

In some embodiments, the shape of the liquid frozen contents is formed by freezing the liquid in an external mold, on a freeze plate, or as droplets falling through a cryogenic atmosphere and inserting the frozen contents into the pod as a solid.

In some embodiments, a liquid frozen content is formed by freezing the liquid around or upon a chilled probe and subsequently heating the probe to release the solid frozen contents into the pod as a solid.

In some embodiments, the liquid contents are frozen in a mold, thawed around the periphery to ease displacement from the mold, and then placed into the pod using some method of transport such as a mechanical suction cup or claw arm.

In some embodiments, the shape of the liquid frozen contents is formed by extruding the liquid through a chilled tube or die, causing the liquid to freeze in the shape of the tube or die cross-section, trimming the extruded shape to a desired length, and inserting it into the pod as a solid.

In some embodiments, the liquid content is applied to a freeze plate where it is allowed to freeze, then scraped and formed into a specific shape, and placed into the pod.

In some embodiments, the liquid content is run through a sieve and dispersed through a cryogenic atmosphere or into a cryogenic bath to form multiple small spherical droplets and these frozen small spheres are subsequently collected, positioned, and sealed within a pod.

In some embodiments, a method for manufacturing a frozen liquid beverage product includes the steps of positioning in a first orientation a receptacle having an end layer, a side wall surrounding the end layer, and an open top opposite the end layer, the end layer and side wall defining a receptacle volume; disposing a liquid beverage product in the receptacle, the liquid beverage product occupying less than the entire receptacle volume; freezing the liquid beverage product to form a frozen liquid beverage product conforming to a first portion of the end layer and a first portion of the side wall; thawing at least a portion of the frozen liquid beverage product to release the frozen liquid beverage product from the first portion of the end layer and the first portion of the side wall; repositioning the receptacle into a second orientation different from the first orientation; and refreezing the at least a portion of the frozen liquid beverage product such that the refrozen liquid beverage product contacts at least one of: a second portion of the end layer different from the first portion of the end layer, and a second portion of the sidewall different from the first portion of the sidewall.

In some embodiments, the method further includes sealing the open top with a top layer before the repositioning the receptacle, wherein the repositioning the receptacle and the refreezing forms the refrozen liquid beverage product with a shape and position that, in part, defines a headspace between the refrozen liquid beverage product and a center of the top layer and a headspace between the refrozen liquid beverage product and the end layer.

In some embodiments, the method further includes sealing the open top with a top layer before the repositioning the receptacle, wherein the repositioning the receptacle and the refreezing forms the refrozen liquid beverage product with a shape and position that, in part, defines at least one flow path between a center of the top layer and a point on the end layer.

In some embodiments, the freezing the liquid beverage product to form a frozen liquid beverage product conforming to the first portion of the end layer and the first portion of the side wall comprises positioning the receptacle in the first orientation such that the liquid surface is not parallel to the end layer.

In some embodiments, the refreezing the at least a portion of the frozen liquid beverage product comprises adhering the refrozen liquid beverage product to at least one of: the second portion of the end layer different from the first portion of the end layer, and the second portion of the sidewall different from the first portion of the sidewall.

In some embodiments, a method for manufacturing a frozen liquid beverage product includes the steps of: providing a receptacle having an end layer, a side wall surrounding the end layer, and an open top opposite the end layer, the end layer and side wall defining a receptacle volume; disposing a liquid beverage product in the receptacle, the liquid beverage product occupying less than the entire receptacle volume, and the liquid beverage product defining a liquid surface; positioning the receptacle in an orientation such that the liquid surface is not parallel to the end layer; and freezing the liquid beverage product to form a frozen liquid beverage product conforming to at least a first portion of the side wall or a first portion of the end layer.

In some embodiments, the method further includes sealing the open top with a top layer, wherein the positioning the receptacle and the freezing the liquid beverage product forms the frozen liquid beverage product with a shape and position that, in part, defines a headspace between the frozen liquid beverage product and a center of the top layer and a headspace between the refrozen liquid beverage product and the end layer.

In some embodiments, the method further includes sealing the open top with a top layer, wherein the positioning the receptacle and the freezing the liquid beverage product forms the frozen liquid beverage product with a shape and position that, in part, defines a frozen liquid surface of the frozen liquid beverage product opposite the top layer that is not parallel with the top layer.

In some embodiments, the method further includes sealing the open top with a top layer, wherein the positioning the receptacle and the freezing forms the frozen liquid beverage product with a shape and position that, in part, defines at least one flow path between a center of the top layer and a point on the end layer.

In some embodiments, the freezing the liquid beverage product occurring during the positioning the receptacle, the positioning the receptacle comprising rotating the receptacle.

In some embodiments, a method for manufacturing a frozen liquid beverage product includes the steps of: cooling an elongate die having a substantially continuous cross-section in an extrusion direction from an entrance end to an exit end; passing liquid beverage product from the entrance end along the extrusion direction to the exit end such that the liquid beverage product becomes a frozen liquid beverage product; trimming a portion of the frozen liquid beverage product extending beyond the exit end to form a frozen liquid beverage product preform; and positioning the frozen liquid beverage product preform into a receptacle, the receptacle having an end layer, a side wall surrounding the end layer, and an open top opposite the end layer, the end layer and side wall defining a receptacle volume; sealing the open top with a top layer, wherein the passing, trimming, and positioning forms the frozen liquid beverage product preform with a shape and position that, in part, defines at least one of: a headspace between the frozen liquid beverage product preform and a center of the top layer, a headspace between the frozen liquid beverage product preform and the end layer, and at least one flow path between a center of the top layer and a point on the end layer.

In some embodiments, the trimming the portion of the frozen liquid beverage product extending beyond the exit end comprises trimming at an angle that is not perpendicular to the extrusion direction.

In some embodiments, a method for manufacturing a frozen liquid beverage product includes the steps of: positioning a probe tip into liquid beverage product; freezing at least a portion of the liquid beverage product around the probe tip; providing a receptacle, the receptacle having an end layer, a side wall surrounding the end layer, and an open top opposite the end layer, the end layer and side wall defining a receptacle volume; transferring, with the probe, the frozen portion of the liquid beverage product to the receptacle; positioning the frozen portion of the liquid beverage product within the receptacle volume; and sealing the open top with a top layer, wherein the freezing and the positioning the frozen portion of the liquid beverage product forms the frozen liquid beverage product with a shape and position that, in part, defines at least one of: a headspace between the frozen liquid beverage product and a center of the top layer, a headspace between the frozen liquid beverage product and the end layer, and at least one flow path between a center of the top layer and a point on the end layer.

In some embodiments, the transferring and the positioning are performed concurrently.

In some embodiments, the positioning is performed after the sealing the open top.

In some embodiments, the positioning the probe tip into the liquid beverage product comprises positioning the probe tip into a mold containing liquid beverage product.

In some embodiments, the positioning the probe tip into the liquid beverage product comprises positioning the probe tip into a liquid beverage product reservoir containing liquid beverage product.

In some embodiments, the freezing at least the portion of the liquid beverage product around the probe tip comprises freezing less than the entire amount of liquid beverage product in the liquid beverage product reservoir.

### BRIEF DESCRIPTION OF THE DRAWINGS

FIG. 1 is a section view of a frozen concentrated extract in a pod.

FIG. 2 is a section view of liquid extract frozen after a pod is placed on its side, according to an embodiment.

FIG. 3 is a section view of a modified embodiment to that shown in FIG. 2.

FIGS. 4, 5, and 6 are section views of a pod illustrating some embodiments of a freeze, melt and refreeze approach to shape the pod contents.

FIG. 7 is a section view of a pod illustrating an embodiment of a freeze, melt and refreeze approach to shape the pod contents,

FIGS. 8, 9, and 10 are section views of pods illustrating the effects of freezing the contents of a pod while it is rotating, according to an embodiment.

FIG. 11 is a section view of a pod illustrating the effects of freezing the contents of a pod while it is being tumbled, according to an embodiment.

FIG. 12 is a section view of a pod containing a necked spherical preform, according to an embodiment.

FIG. 13 is a section view of a pod containing a hollow, generally cylindrical preform, according to an embodiment.

FIGS. 14 and 15 are section views of a pod containing a hollow cylindrical preform created by freezing in two different orientations, according to some embodiments.

FIGS. 16 and 17 are section views of a pod containing two exemplary extruded preforms, according to some embodiments.

FIGS. 18A-18D are section views of a pod containing a preform with flats on the sides of the frozen contents, according to some embodiments.

FIG. 19 is a section view of a pod containing a parallelepiped-shaped frozen contents, according to an embodiment.

FIGS. 20A and 20B are section and isometric views of a truncated cone preform with side reliefs, according to some embodiments.

FIGS. 21A and 21B are section and top views of a truncated pyramid sized so the pyramid corners contact the tapered walls of the pod, according to some embodiments.

FIG. 22 is a section view of an undersized truncated pyramid positioned within a pod with contacts between multiple corner and the pod sidewalls, according to an embodiment.

FIGS. 23A-23C are isometric sketches of a portionprobe-based preform manufacturing system, according to some embodiments.

FIGS. 23D-23F are frontal and isometric sketches of a preform being loaded into a pod and a view once the handle has been removed, according to some embodiments.

FIG. 24 is an isometric sketch of one embodiment of a preform extrusion system.

FIG. 25 is a section view of a chilled extrusion die, according to an embodiment.

FIG. 26 shows an injection molding system, according to an embodiment.

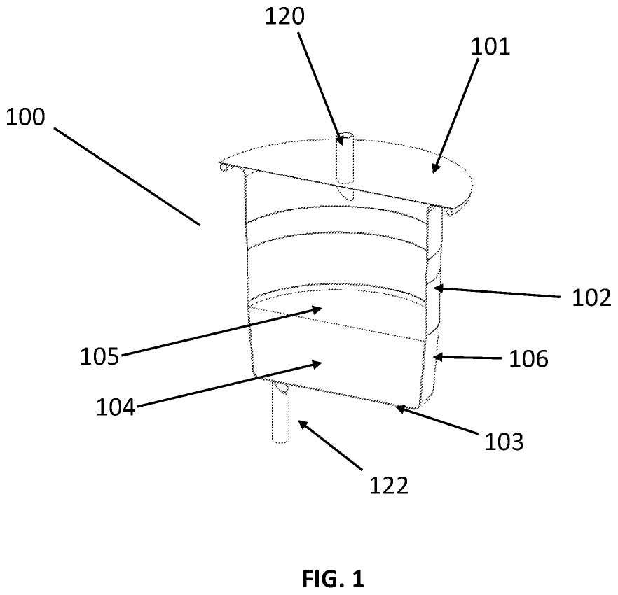

As noted above, concepts shown in FIGS. 1-26 are exemplary in nature and intended to illustrate means of creating the liquid frozen contents slug. Whether formed in place, with or without fixturing or dynamic effects, or performed by any of a variety of methods, the intent in all cases is to provide a more natural or more easily formed flow path from entrance to exit needles while still providing needed interaction between the melting/diluting liquid and the frozen slug.

### DETAILED DESCRIPTION

The figures in the accompanying document and the descriptions of those figures below illustrate multiple solutions to the problem of creating a flow path for a melting/diluting liquid introduced to the inside of a pod containing a liquid frozen content. It will be recognized by one skilled in the art that similar geometric shapes or combinations of these or similar shapes will accomplish the same objective. What they have in common are geometries which create either obstruction-free pathways independent of a need for either needle to displace a frozen slug/preform or needle obstructions which are sufficiently thin that they can be easily broken by a needle without displacement.

It should be noted that in the various figures which are shown and described, the volume of the frozen contents is approximately the same. As this volume is increased or decreased in production to accommodate various beverage strengths, volumes and extract concentrations, the relative sizes of the displayed solutions will vary proportionally.

Additionally, for all the methods cited below, it is assumed that the process of forming and packaging the liquid frozen contents, including those made using a preforming process, occurs in an oxygen free environment to minimize loss of flavor or aroma due to unwanted oxidation reactions.

FIG. 1 illustrates a configuration 100 for loading and freezing the concentrated extract taught by U.S. Pat. No. 9,630,770. The pod comprises a receptacle with a lid 101, a sidewall 102, and a continuous end layer 103. The frozen content 104 conforms to the bottom 103 and lower sidewalls 106 of the pod and the interface 105 with the headspace gases in the pod is a flat plane normal to the pods axis of symmetry. When a needle enters vertically through the bottom of the pod 103 near the outer edge of the pod bottom, it will normally lift the frozen contents. The tapered sidewalls 102 of the pod allow and promote this release and movement. As the slug moves vertically, it creates an ever-widening gap between the sides of the slug and the sides of the pod owing to the tapered/conical geometry of both. Problems can occur, however, if the needle penetrates the frozen slug without displacing it, as it then becomes impossible for water entering the pod from the entrance needle to reach the exit. In addition, unwanted strain may be put on the machine to dislodge the frozen slug.

In some embodiments, the frozen content 104 of FIG. 1 may be dislodged away from the bottom of the receptacle 103 at some point in time, including before the pod is placed into a dispenser, by at least one of an external force or impact, a rapid deceleration of the pod, or a heating of the pod sufficient to melt the interfacial layer between the frozen contents and the sidewall 102 thereby allowing the contents to move freely inside the pod to create a flow path.

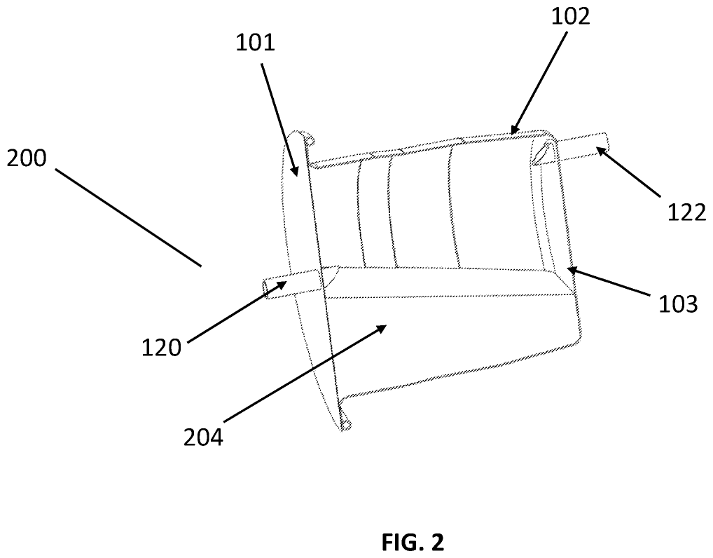

Referring to FIG. 2, in some embodiments the liquid extract 204 is frozen after the pod is placed on its side so the contents pool along the lowest portions of the sidewall 102. The geometry shown reflects the pod resting naturally in contact with some restraining surface (not shown) supporting the outer flange of the lid 101 and the corner of the bottom end 103/sidewall 102. This solution will be fully effective only if the pod is placed into the brewer with the headspace portion of the interior oriented toward the bottom needle 122's circumferential location. If placed such that the bottom needle impacts the bottom end of the frozen contents 204, an over-pressure problem is more likely to occur as displacing this geometry will be more difficult than displacing slug 104 of FIG. 1. As shown in FIG. 2, top needle 120 does not have any obstruction regardless of the orientation of the pod. Proper orientation of the frozen contents 204 relative to the bottom needle 122's circumferential location may be accomplished by using, for example, but not limited to, tabs on the pod and corresponding receptors on the receiving socket, markings provided on the surface of the pod (such as on the lid 101) for a user to demonstrate proper orientation of the pod, and/or gravity causing the heavy part of the pod with the frozen contents 204 to move to the desired location.

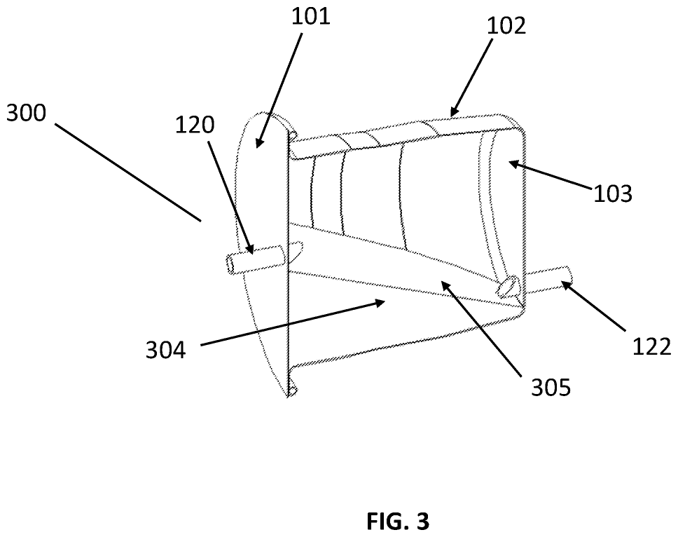

Referring to FIG. 3, the pod 300 is positioned in an orientation during freezing of the liquid contents which displaces the interface 305 of the frozen contents and headspace to a position that allows the needles 120, 122 to enter freely or be required to only penetrate a thin/weak section of the slug.

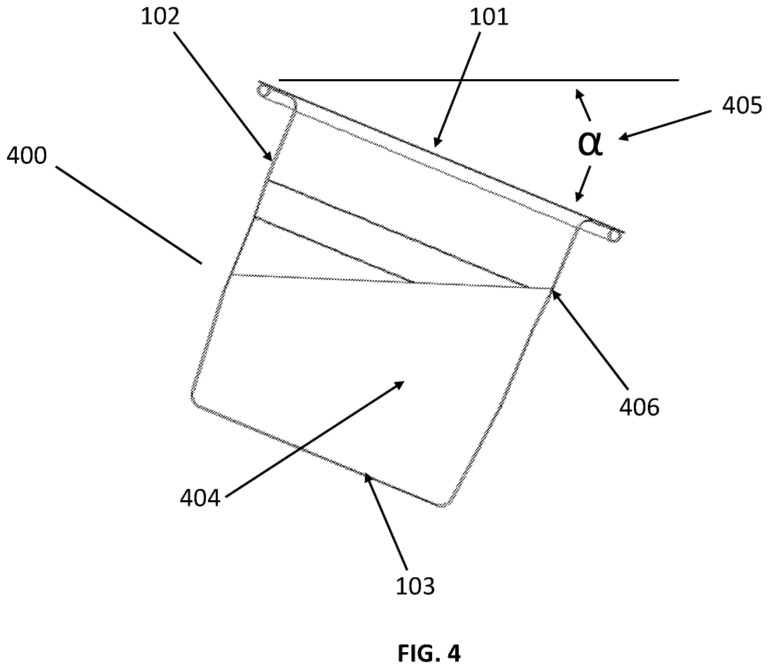

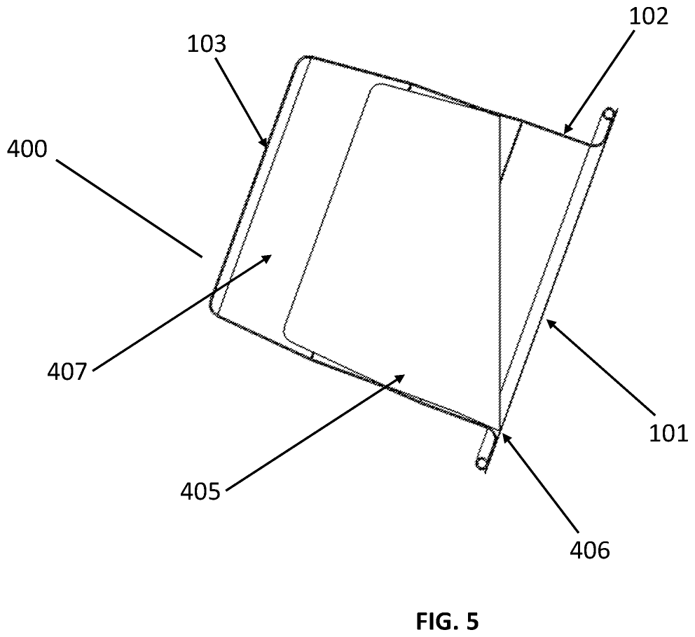

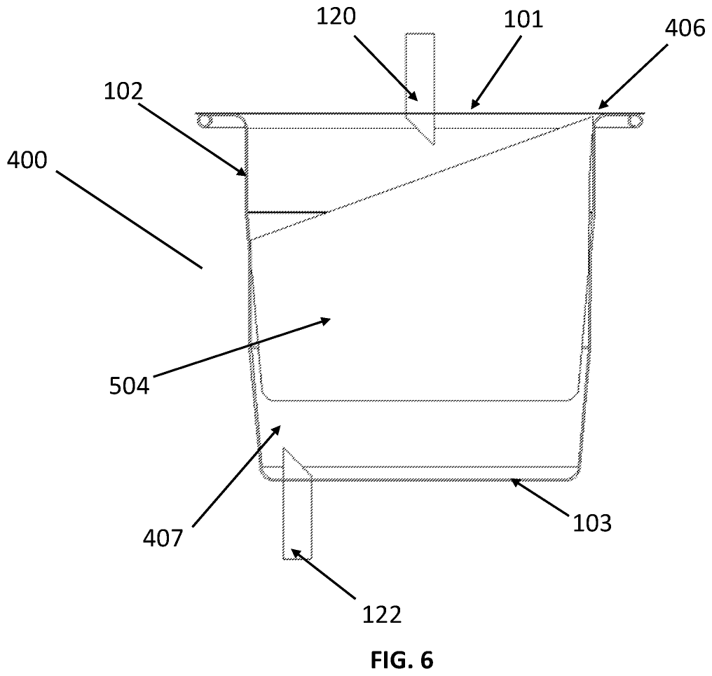

Referring to FIGS. 4, 5 and 6, in some embodiments, a pod 400 with liquid contents 404 (at a time before or after the pod is filled and the lid 101 is fixed in place) is oriented at an angle “α” 405 generally as shown in FIG. 4. This angle is intended to place the deepest edge 406 of the liquid contents 404 (relative to the bottom 103 of the receptacle) at a closer distance to the lid 101 along the sidewall 102. Held in this position, the pod may be partially or fully immersed in a chilled bath (e.g., liquid nitrogen, chilled glycol or another refrigerated medium such as a liquid or gas or held in a tunnel freezer) and the liquid contents 404 allowed to freeze. According to some embodiments, this pod 400 with its frozen contents 405 is then positioned in a new orientation like that shown in FIG. 5 and briefly warmed to cause the interface between the frozen contents and the pod sidewall 102/bottom 103 to liquify and allow the frozen contents 504 to slide toward the lid 101. The lid 101 stops this movement, leaving a gap 407 (e.g., headspace) across the entire bottom 103 of the receptacle, but without significantly interfering with the headspace at the lid 101 centerline needed for entrance needle penetration. Once the slug of frozen contents 504 has slid into this position, the pod is re-cooled/re-frozen such that the liquified interface solidifies and adheres to points of contact with the sides 102 of the pod, preventing it from sliding back toward the bottom 103, even when the pod is reoriented as in FIG. 6 (which uses the same reference numbers to show like elements) for insertion into a dispenser. This orientation of the frozen contents 504 creates a natural pathway for the diluting liquid to move from an entry needle 120 penetrating the center of the lid 101 to a puncture point created by the exit needle 122 in the bottom 103 of the pod. In some embodiments, the slug is refrozen while the pod is held in the same position as the position during warming step. In some embodiments, the receptacle is positioned to preferentially allow any thawed liquid to pool in a preferred location to further enhance clearance for one or both needles, for example, placed on its side so any thawed liquid pools to the bottom facing sidewall 102 rather than nearer to the lid 101. In another embodiment, the pod is refrozen with the sidewall 102 of the pod in a horizontal orientation, so any thawed liquid adheres to only one segment of the sidewall 102.

As an example, purely for illustration, for a pod generally having the profile of a WinPak® C-150 cup (i.e., a K-cup like pod), and for a liquid content weighing approximately 20-26 grams, one orientation angle, a 405, that has been demonstrated to work efficiently is 20°, referred to hereinafter as the “Winkler Angle.” The Winkler Angle may be adjusted from this 20° angle based on the total fill volume within the pod, as discussed in more detail below. For fills greater than 26 grams in the same cup, for example, the Winkler Angle may be reduced to prevent portions of the slug from obscuring the center of the lid 101 where the needle is expected to penetrate. In another example, for fills less than 26 grams in the same cup, the Winkler Angle may be increased to increase the amount of headspace from the bottom 103 without obscuring the center of the lid 101. Also, purely for illustration, the thawing of the interface layer between frozen contents and pod may be accomplished by various means such as hot air, steam, immersion in water, RF/induction heating of the pod (assuming it is electrically conductive), a heated contact block, etc. In practice, an IR oven has been demonstrated to work efficiently. According to some embodiments, the heating method does not wet the exterior cup surface with water, thereby avoiding any frost or ice on the outside of the container, but these approaches are technically possible.

For other cup sizes/shapes and fill volumes, the orientation of the tilt angle could vary from approximately 5° to approximately 60°, such as from 15° to 25°, but, having the benefit the disclosure of this novel technique, one skilled in the art can quickly determine an optimum angle for best results of this freeze/thaw/refreeze approach given parameters such as, but not limited to, the pod size, contents, and intended brewing system.

In some embodiments, the content may initially be frozen by exposing the pod to a temperature far below the freezing point of the liquid contents, creating a substantial “reservoir of coldness” within the slug of frozen contents that can be used to refreeze any liquid created during a subsequent thawing of the receptacle/contents interface as described above. This refreezing can be used to lock the slug in a new location within the receptacle after it has been dislodged from its original location. For example, if the frozen slug approximates the temperatures of liquid nitrogen (−321 degrees Fahrenheit) and the interfacial layer is thawed for release, then the internal temperature of the slug may refreeze the liquefied portion once heat is no longer applied to the exterior of the pod. According to some embodiments, locking the slug to a new location may involve the slug naturally attaching to the walls 102 of the pod during the refreezing process, or may involve forming a shape such that the slug cannot move about easily within the interior of the pod.

In some embodiments, the temperature of the pod is read using a sensor to calculate the amount of heat that should be applied to the outside of the pod to thaw the interfacial layer. Thermal imaging and related sensory technology may be used to ensure the slug thaws and refreezes in the desired location properly. The detected temperature of the pod may be used to increase or decrease the duration of the pod's exposure to a freezing or heating environment and/or the temperature of the freezing or heating environment.

In some embodiments, the successful thaw and refreeze may be inspected to ensure the areas covering the anticipated position of needle puncture are empty. In some embodiments, this inspection occurs using at least one of visually observing the location of frost on the outside of the pod, visually observing the orientation of the pod as it floats in a liquid bath (e.g., a liquid nitrogen refreeze bath), the use of a gyroscope and/or accelerometer to determine center of gravity, or use of a tap tone test.

In some embodiments, inspection of the pod to determine the location of the slug may be conducted using one of ultrasonics, X-rays, or other similar diagnostic tools well known in the art.

In some embodiments, quality assurance of the manufacturing methods and techniques disclosed herein can be performed by simply observing the orientation of a cup as it floats in a liquid (e.g., a liquid nitrogen bath) during/after refreezing. Because the shift of the frozen slug toward the lid 101 will noticeably change the center of gravity of the pod, pods wherein the slug has not shifted will be oriented with the rotational axis of the pod pointed more vertically than normal. Such pods can easily be identified and removed from the production stream for retreatment.

In some embodiments a deformable dome in the bottom 103 of the pod, as taught in U.S. Pat. No. 9,346,611, is used to hold the frozen contents away from the bottom 103 of the pod. The dome is originally extended outward from the pod bottom 103 when the liquid contents are first frozen. Then following this initial freezing, with or without a slight melting of the interface as described above, the dome can be mechanically pushed into the pod to support the bottom 103 of the frozen contents in a raised position. In some embodiments, vibration may be used to assist in dislodging the frozen slug.

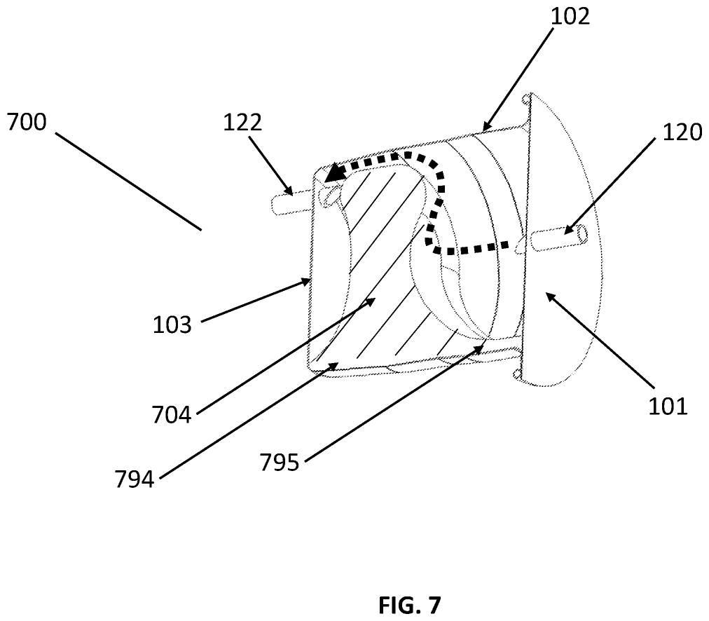

Referring to FIG. 7, in some embodiments, the configuration 700 is formed by first filling and freezing the liquid contents 104 as described for the slug in FIG. 1, then allowing the outer edges of the slug to melt and refreezing the modified shape contents 704 with the pod resting on its side. This solution is particularly simple to implement and creates a viable flow path for any orientation of the pod in the brewer. It requires that the melting process be carefully controlled to avoid excessive sidewall reduction to the original slug. In particular, according to an embodiment, the frozen contents 704 may first be formed as described with respect to FIG. 1. Then, the frozen contents 704 may be shifted toward the lid 101 from the bottom 103 along the side wall 102, for example by placing the pod on its side as shown in FIG. 7. This may be combined with heating and/or agitation in order to ensure proper location of the frozen contents 704. Upon proper location of the frozen contents 704, the frozen contents 704 may be partially melted to form pool portions 794, 795, and then refrozen to form the shape of frozen contents 704 shown in FIG. 7. Accordingly, the frozen contents 704 allow for entry of the top needle 120 and bottom needle 122 with headspace adjacent bottom 103 and lid 101. It also allows for a flow path (dotted line) from the entry point to the exit point.

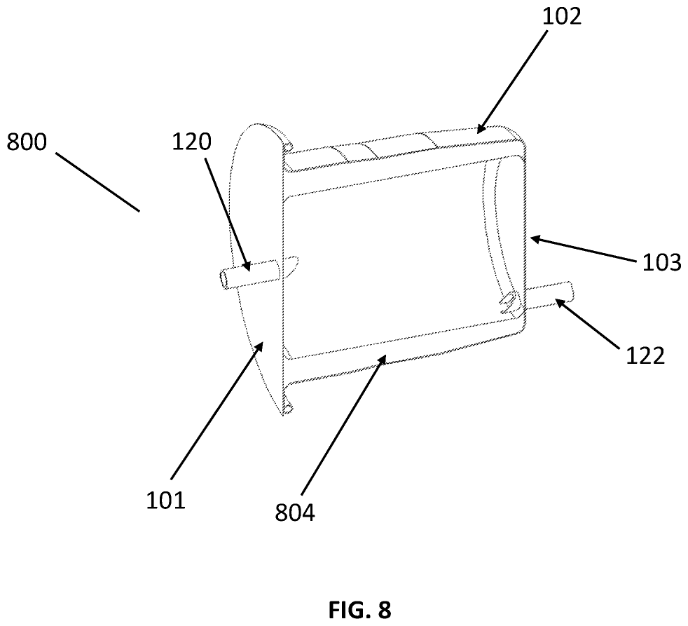

Referring to FIG. 8, in some embodiments a configuration 800 involves a more dynamic solution. It is achieved by placing the pod with packaged liquid extract 804 on its side and spinning the pod about its axis of symmetry while it freezes, for example, by placing it in a liquid nitrogen (LN2) bath during spinning A thin layer of extract 804 freezes to the portion of the sidewall 102 in contact with the LN2 as the pod is initially spun and this layer grows thicker and uniformly as the pod continues to spin. Both ends are left open except at the outer periphery (owing to some freezing of the end layers since the pod is slightly immersed into the LN2) and even if this layer intersects the point of bottom needle 122 puncture through bottom 103, it is thin enough that it will fracture/spall easily at the point of puncture. Entry of the top needle 120 through lid 101 is not obstructed. This geometry presents a large surface area to the incoming liquid, promoting rapid heat transfer and melting. It also creates a very direct flow path for incoming liquid so interaction with the frozen contents may be compromised.

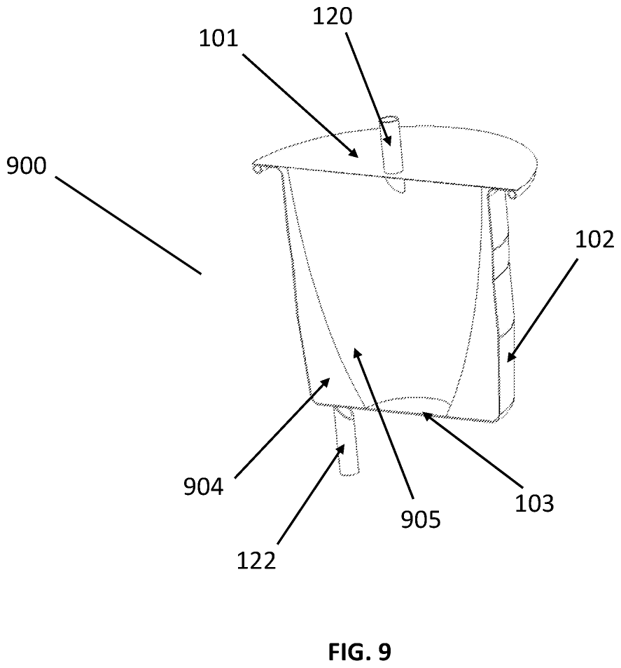

Referring to FIG. 9, in some embodiments, an alternative configuration 900 also involves another dynamic solution and fixturing. This geometry is achieved by immersing the pod in LN2 with its axis of symmetry pointed vertically and rapidly spinning the pod such that the liquid displaces similarly to what occurs in a centrifuge, forming the frozen contents 904 into a parabolic surface 905 along sidewalls 102 and bottom 103 at the extract/headspace interface. This configuration creates significant headspace for top needle 120. However, it should be noted that this example creates a thick section at the point of bottom needle penetration and more surface area contact with the pod sidewalls 102, thereby increasing the difficulty in displacing the slug upward. However, similar techniques described above may be used to displace the frozen contents 904 toward the lid 101, thereby reducing interference with the bottom needle 122.

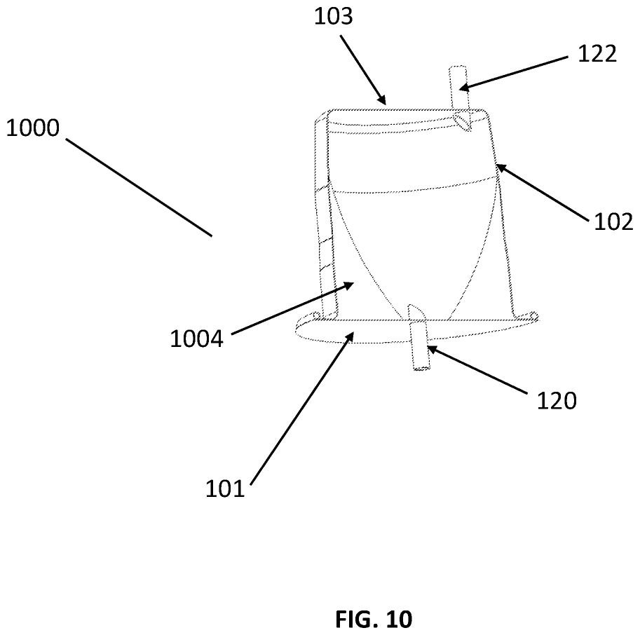

Referring to FIG. 10, in some embodiments, the configuration 1000 is achieved using an approach like that of FIG. 9, but with the pod spun in an upside-down orientation (i.e., with the top 101 oriented downward below the bottom 103) to create frozen contents 1004. This solution creates an excellent slug profile as both the needle entrance locations for top needle 120 and bottom needle 122 are free of obstruction and the joint between the lid 101 and the flange is reinforced with a thick section of frozen material along sidewalls 102 and around lid 101 that will further reduce any oxygen migration that might otherwise occur through the interface, such as an interfacing polymer. However, the flow path from entrance to exit can occur with little interaction with the frozen contents, so melting of the frozen contents may be compromised.

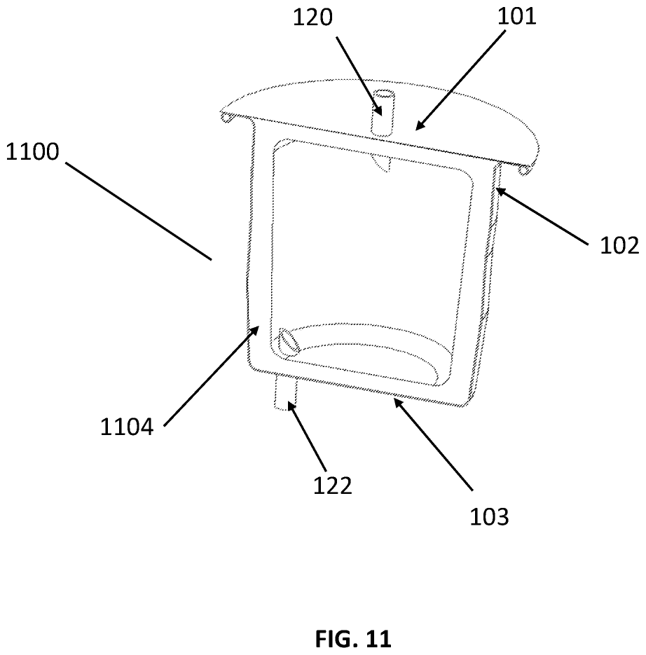

Referring to FIG. 11, in some embodiments, the configuration 1100 is achieved by tumbling or shaking the pod in LN2, other cooled liquids, and/or in a refrigerated environment in a random way or in accordance with a series of programmed moves/orientations which create a thin layer 1104 over most or every part of the inside surface of the pod (e.g., along sidewalls 102, lid 101, and bottom 103). The needle entry locations for top needle 120 and bottom needle 122 are covered, but with the contents spread over the full inside surface area of the pod, the resulting wall thickness is thin and more easily penetrated by the needles. This approach maximizes the surface area available for heat transfer, both during freezing and melting. However, the machinery to controllably tumble the pod during freezing, e.g., with robotic arms, rotating tub such as that used for mixing concrete and filled with a liquid or gas coolant, or controlled actuators can be used as well as more simple examples, such as allowing the pods to tumble “free-form” within a larger volume of LN2 which is randomly agitated to cause multiple pods to tumble. Care may be taken to avoid damaging the exterior appearance of the pods.

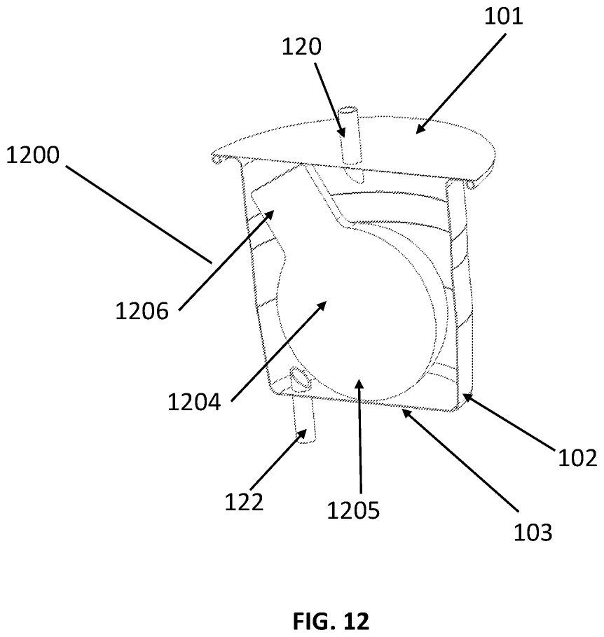

Referring to FIG. 12, in some embodiments, a preformed slug 1204 (shown in cross-section), made outside of the pod, is used. For example, flexible silicone tooling or a stainless-steel injection mold may be used for forming the desired shape. This exemplary shape is one of many that could be created from such tooling with the objective of making them in mass, quickly loading them already frozen into a pod, and thereafter attaching the lid 101. The shape can be chosen to avoid interference with one or both of top needle 120 and bottom needle 122 and create large surface areas for rapid melting from the dispensed fluids. Use of a pre-frozen slug eliminates concerns about sloshing of the liquid during packaging operations (and inadvertent wetting of the welding flange), meaning that the packaging line can produce at a higher rate. As shown in FIG. 12, the molded slug 1204 has a spherical bottom 1205 and a tube-like protrusion 1206. The spherical bottom rests on the bottom 103 of the pod and is sized such that it does not interfere with the entry point of bottom needle 122. The tube-like protrusion 1206 may be provided to prevent a certain degree of rotation of the spherical bottom 1205 and may be designed to avoid interference with the entry of top needle 120 (and to prevent the spherical portion 1205 from affixing itself to the lid 101 at the center thereof in a way that would interfere with entry of top needle 120). It should be appreciated that other shapes are contemplated, and the slug 1204 is shown by way of a non-limiting example.

In some embodiments, such as those described above and in the remainder of the present disclosure, the preform may be produced into a size and shape such that the preform may be positioned within the interior of the pod wherein contact points or surfaces of the preform and the interior of the pod create a continuous flow space between the preform and the puncture area in the top diameter (e.g., lid 101), along the sidewall 102 and/or the preform itself, and out through the puncture area in the bottom 103 surface of the pod.

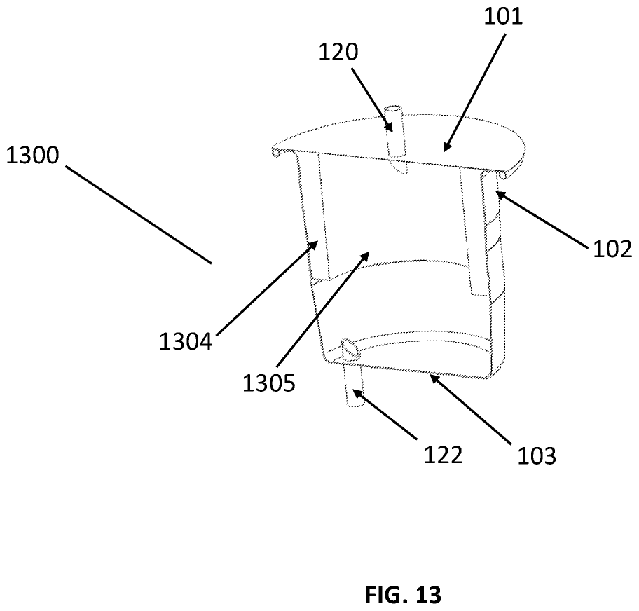

FIG. 13 shows a similar embodiment to FIG. 10 except that the frozen contents 1304 are generally parallel with side walls 102, and do not extend parabolically along lid 101. The frozen contents 1304 beneficially do not contact the entry point of the bottom needle 122 or interfere with the entry point of the top needle 120. Frozen contents 1304 may be formed via an extrusion method or molding method described below. The inside surface 1305 may be formed using, for example, a probe.

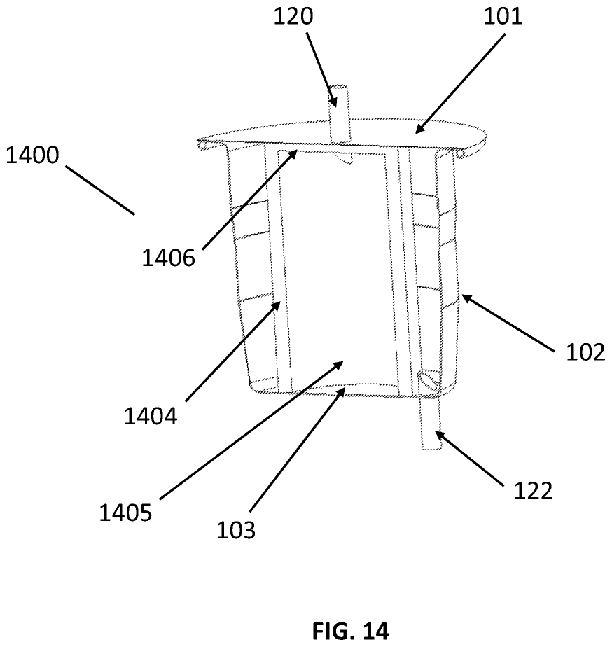

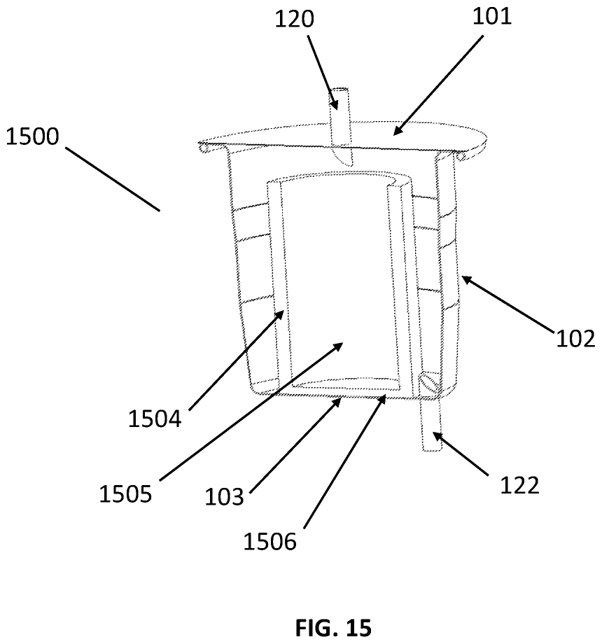

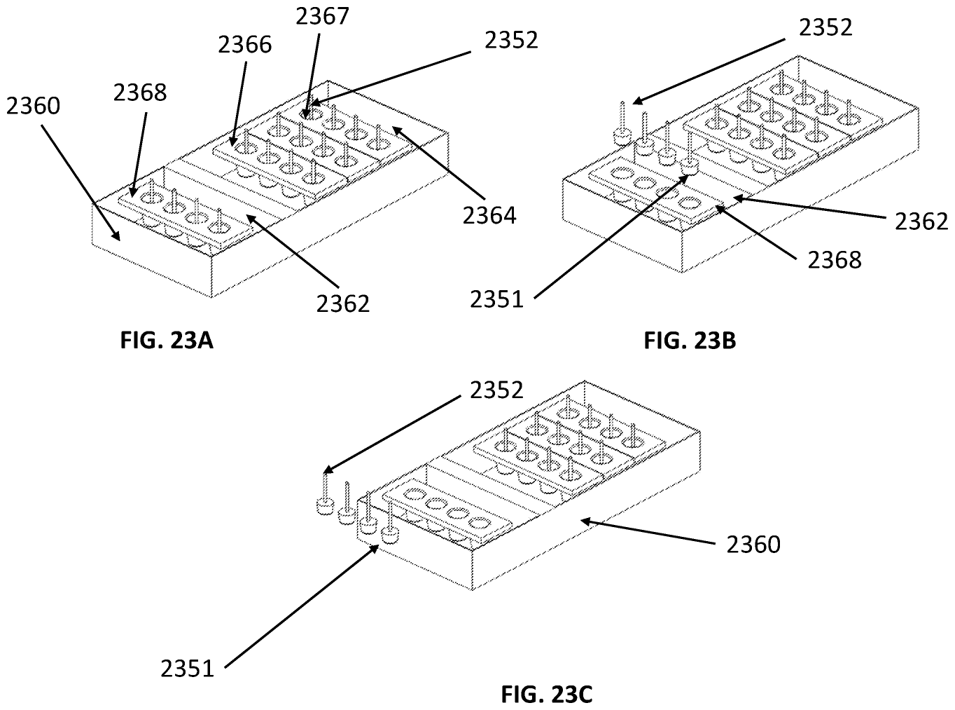

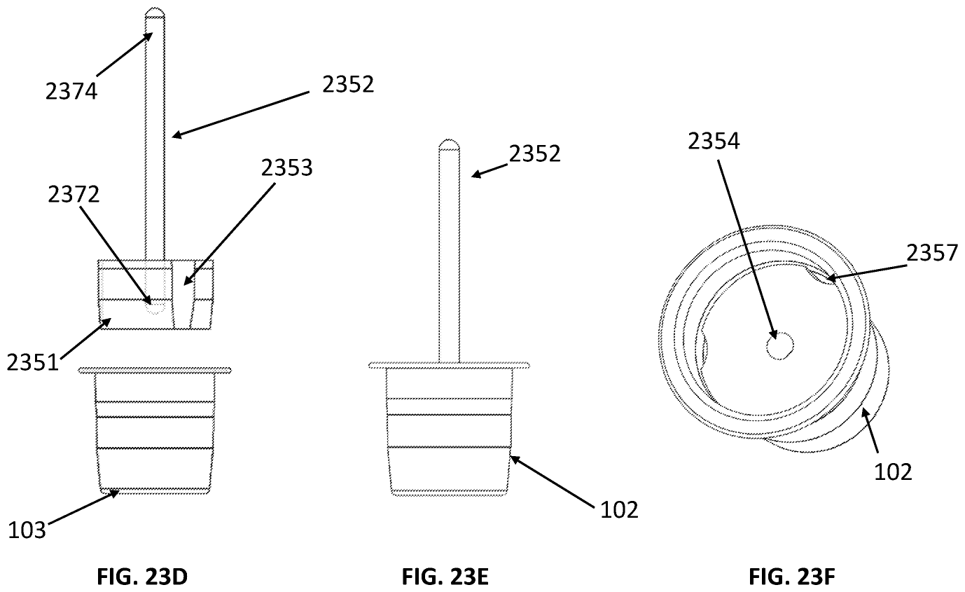

Referring to FIGS. 14 and 15, in some embodiments, a preform 1404 or 1504 can be made in a process similar to that described for FIG. 13. In these instances, the preforms are formed around a chilled probe or handle (for example as described with regard to FIGS. 23A-23F), but external tooling to shape the preform is not used. The preform is created by causing bulk liquid extract to freeze around a refrigerated probe until sufficient thickness is built up, whereupon the probe is extracted from the bulk liquid and the preform transferred to a pod as described above. These types of preforms are of interest because they may be produced using arrays of probes coordinated in spacing and layout to rapidly load a 12-off or 24-off packaging line, for example. As can be seen in FIGS. 14 and 15, the preform may be deposited into the pod in one of two orientations.

As shown in FIG. 14, the preform 1404 is a generally tubular shape having a closed top 1406 along the lid 101 and an open center 1405 leading to the bottom 103. The preform 1404 does not contact the side walls 102. Beneficially, the top needle only has to penetrate the thin closed top 1406 of the preform 1404, and needle 122 is not obstructed by the preform 1404. Liquid may enter at the center of the lid 101 and pool within the open center 1405 until the edges of the preform 1404 melt, thereby allowing liquid to exit through the bottom 103.

The example shown in FIG. 15, which has an open center 1505 facing the lid 101 and a closed bottom 1506 along bottom 103, has the benefit over the example shown in FIG. 14 that it is (a) easier to off-load from the probe and (b) provides a clearer flow path to the exit if made just slightly shorter than the overall pod height. The entry points for needles 120 and 122 are not obstructed, and liquid may pool in the preform 1505 until it melts the preform 1505 or overflows and exits through the hole made by needle 122.

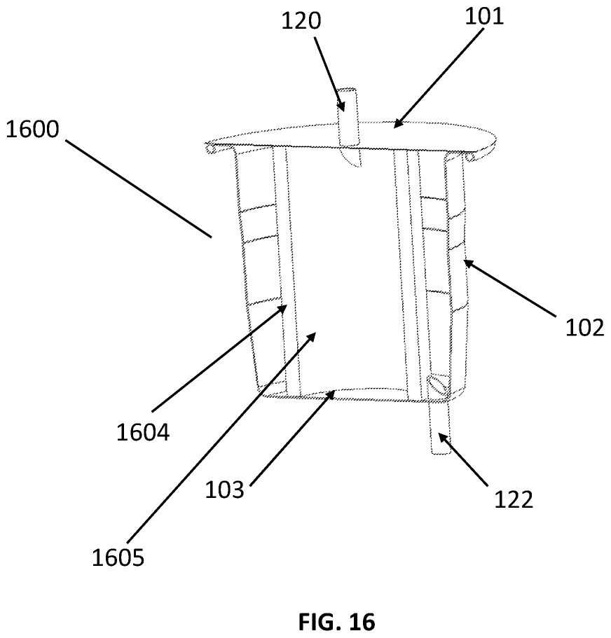

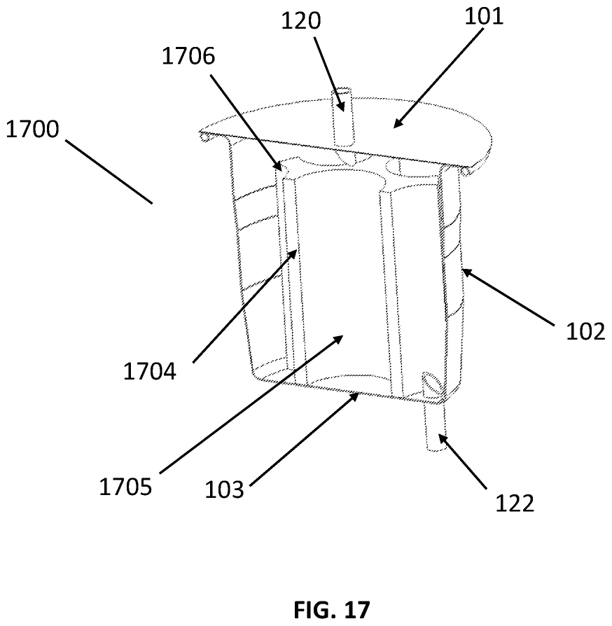

Referring to FIGS. 16 and 17, in some embodiments, preforms 1604 and 1704 may take different shapes that can be formed via an extrusion process and cut to size using, for example, a hot wire or hot blade as described in more detail below. These preforms can be made very rapidly with chilled dies and subsequent loading of pods, either by hand or using automated equipment to pick and place, for example, preforms into pods. Assuming the preforms are kept cold, loading resembles other dry-goods bulk packaging loading processes. As shown in FIG. 16, the preform 1604 is a tube-like shape having a hollow center 1605 and does not contact sidewalls 102. Similar to the embodiment of FIG. 15, the liquid may pool within the hollow center 1605 until parts of the preform 1604 melt. As shown in FIG. 16, preform 1604 does not interfere with the entrance of needles 120 or 122 through lid 101 or bottom 103, respectively. Use of more complex shapes, as shown in FIG. 17, with, for example, flutes 1706 protruding from the tube-like preform 1704 with hollow center 1705, can increase the available surface area of the preform and thereby improve rates of heat transfer and liquefaction of the preform. In some embodiments, these complex shapes are used as a means of holding or grappling a preform for removal from the mold and transport to a pod. Furthermore, flutes 1706 may reduce the likelihood that preform 1704 moves around within the pod, thereby obstructing the entrance of bottom needle 122. As shown in FIG. 17, preform 1704 leaves extra headspace at the top of the pod underneath lid 101. According to another embodiment, the preform 1704 may extend to the lid 101 like in FIG. 16. As discussed above, suitable elements may be provided to ensure that the needle 122 enters at a proper location between flutes 1706, such as a tab, indent, or protrusion and a corresponding receiver in the pod chamber of a brewing machine. Alternatively, if the flutes are designed to be sufficiently thin, the exit needle should be able to deflect past a flute or cause it to spall away from the rest of the preform during needle entry.

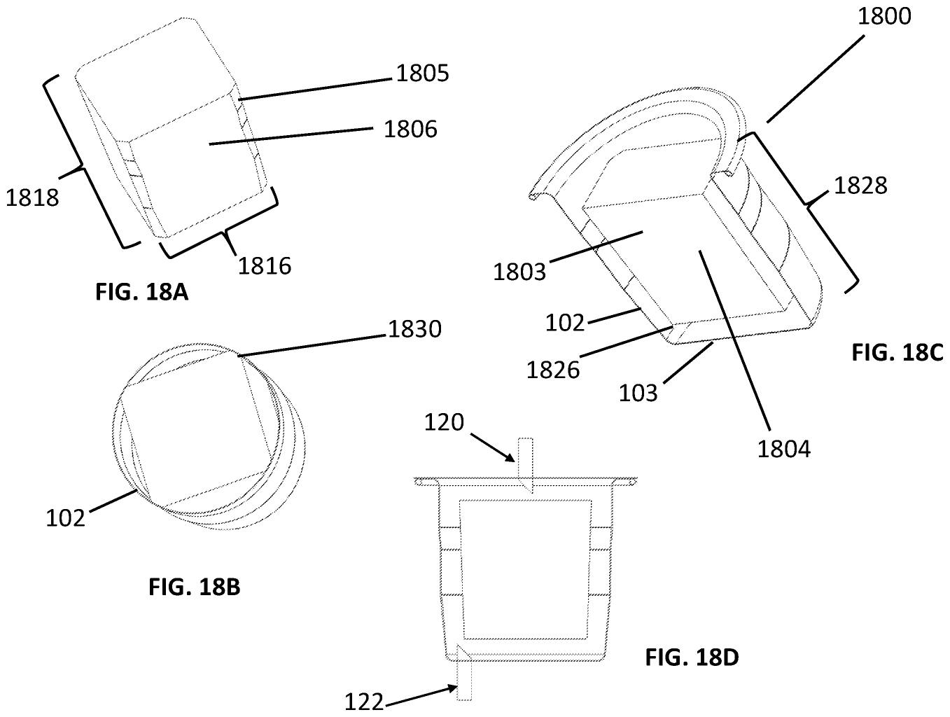

Referring to FIG. 18A-18C, in some embodiments, the preform comprises some feature(s) that naturally suspend it above the bottom 103 of the pod or prevent it from contacting the lid 101. For example, it may have a width or diameter 1816 that is greater than the diameter of a portion of the interior sidewalls 102 of the pod at a particular point 1826 and has a height 1818 less than the height of the pod 1828 such that the frozen preform only contacts the upper and/or lower parts of sidewalls 102 of the pod or the bottom 103 at a few places 1830, keeping the puncture areas for needles 120, 122 clear of any obstruction to needle penetration. In some embodiments, the preform is shaped (for example via molding or extrusion) to have edges 1805 contoured to match or closely approximate the inside contour of pod sidewalls 102 in addition to having flat surfaces 1806 that could be described as truncated portions of a solid preform otherwise molded inside of the pod. These flat surfaces 1806 provide a flow path from the puncture point in lid 101 to the puncture point in bottom 103 caused by needles 120 and 122, respectively. As shown in FIG. 18B, these edges closely align with a portion of the pod sidewalls and support it a short distance above bottom surface 103.

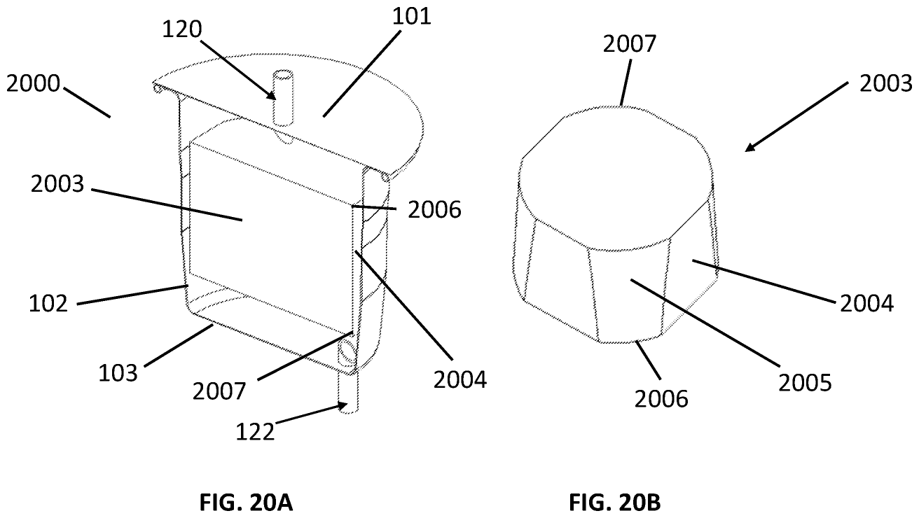

Alternatively, in some embodiments, the exterior sidewalls of the slug are tapered and circular (also known as truncated cone). The frozen preform may be frozen into a truncated pyramid with a height, base width, and taper such that the pyramid may be placed upside down into the pod and rest upon the sidewalls so that it is suspended above the bottom puncture area and below the top puncture zone. The frozen preform may have different shapes and dimensions other than circular surfaces such that flow spaces are created between at least one outside surface of the preform and the interior circular/conical surface of the pod. These embodiments are described in more detail with reference to FIGS. 20A-22.

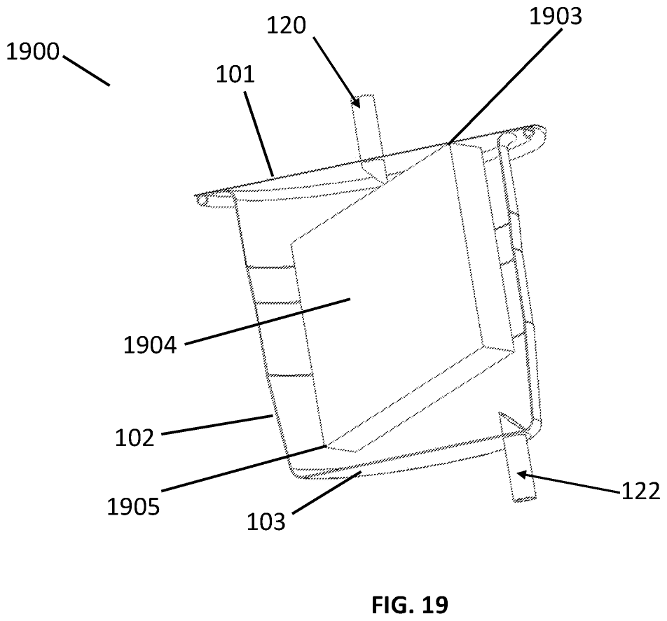

Referring to FIG. 19, in some embodiments, the preform may be formed with a geometry that places an angled edge or point 1903 or 1905 in contact with the interior bottom surface of the pod 103 (e.g., via edge or point 1905) or the lid 101 (e.g., via edge or point 1903), thereby creating clearance above the lower puncture area of the pod produced by needle 122. For example, there are a variety of shapes that may be formed and so positioned to provide this clearance including, but not limited to an extruded rhombus or rectangle and a parallelepiped. FIG. 19 illustrates a parallelepiped preform 1904 so formed and positioned within the pod such that an edge 1903 in contact with the interior lid surface 101 of the pod creates zones of needle clearance both at the top puncture area and the bottom puncture area. This configuration provides headspace adjacent the lid 101 and bottom 103 that allow for entrance of needles 120, 122. It should be appreciated that similar shapes may also use contact with sidewall 102 to allow for headspace adjacent to the lid 101 and bottom 103 to allow for entrance of needles 120, 122.

Referring to FIGS. 20A and 20B, in some embodiments 2000, a preform 2003 may be molded in the shape of a truncated cone and loaded into the pod with the smaller diameter of the cone nearest the bottom 103 of the pod. The dimensions of the truncated cone are chosen such that bottom perimeter 2007 will intersect the tapered sidewall 102 of the pod some distance above the pod bottom 103 such that clearance (headspace) for exit needle 122 is ensured. The overall height of the preform and upper cone perimeter 2006 are selected to ensure contact and support with an upper portion of pod sidewall 102 and adequate clearance (headspace) for entrance needle 120 penetrating through lid 101. Conical sidewalls 2005 provide support along portions of pod sidewall 102, while some form of relief such as cutaways 2004 at one or more locations around the cone circumference ensure a flow path for incoming dilution liquids between entrance needle 120 and exit needle 122.

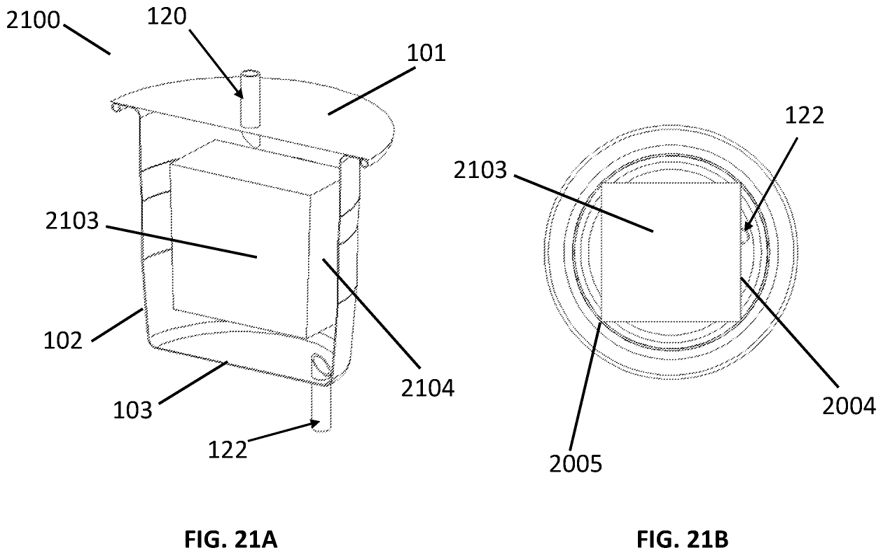

Referring to FIGS. 21A and 21B, in some embodiments 2100, the preform 2103 is molded in the shape of a truncated pyramid. As shown in FIGS. 21A and 21B, in some embodiments this pyramid may have four corners 2005 and four flat sides 2004 that support the preform along pod sidewalls 102. Since the flat sides 2004 are not flush with the sidewalls 102 across the entire cross-section, they provide flow clearance around the preform 2103. In some embodiments, the preform may have as few as three corners and flat sides or many more than four. For any given number of corners and flat sides, the shape and dimensions of the preform may be configured to cause the preform 2103 to rest in the pod sufficiently above bottom 103 for unrestricted exit needle 122 entry, to be supported by contact between corners 2005 and pod sidewalls 102, to allow for flow clearance to the exit hole created by needle 122, and to allow for clearance for entrance needle 120 through the lid 101. The truncated cone of FIGS. 20B is similar to the situation where the number of corners of the truncated pyramid in FIGS. 21A and 21B increases without bound. As with the preform 2003 in FIGS. 21A and 21B, it may be helpful to provide cutaways 2004 where the number of sides increases.

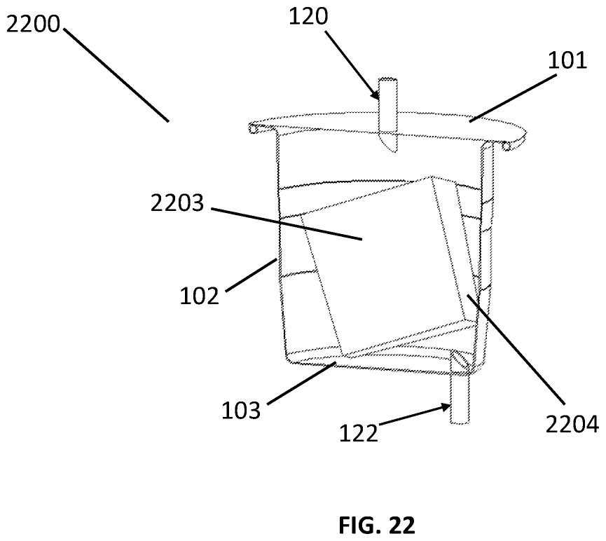

Referring to FIG. 22, in some embodiments 2200, the truncated pyramid of FIGS. 21A and 21B is an undersized pyramid 2203 such that the pyramid corners do not closely match the dimensions and taper angle of the pod sidewalls 102. In this case, the pyramid preform may lie loosely in the pod, resting on one or more edge or corner against the bottom 103 of the pod and at two or more points along pod sidewalls 102. This configuration will also work so long as its overall height is short enough that it can be easily displaced by the exit needle 122 and that, in this displaced position, it has a height such that it does not interfere with entry of needle 120 entering through the lid 101.

Referring to FIGS. 23A-23F, in some embodiments the preform is formed using molding and positioning process. In some embodiments, these molding operations are conducted using a segmented “track” approach. In some embodiments, these molding operations are conducted on a rotary machine. This molding operation can also utilize a variety of direct refrigeration or indirect refrigeration techniques and may also use a probe for cooling and/or manipulation. According to some embodiments, the probe is used without a mold. Thus, the illustrations particularly for FIGS. 23A-23C are meant to be representative and not restrictive.

As shown in FIG. 23A, three “treads” 2366, each containing four preform mold cavities 2367, are shown in the cold side 2364 of process tank 2360. One “tread” 2368 of preform cavities is shown in the warm side 2362 of process tank 2360. The mold cavities on the cold side are immersed in a brine solution or other refrigerant that is chilled, for example to minus 30° to minus 40° Fahrenheit. The size of this cold tank 2364 is selected based on (1) the size of the preform and the associated dwell time required for the preforms to be frozen throughout and (2) desired throughput. The mold cavities 2367 on the warm side 2362 are immersed in a bath of heated liquid, for example water. A short immersion time (e.g., several seconds) is usually sufficient to thaw the interfacial layer between the mold cavity 2367 and preform 2351 to allow the preform to be withdrawn from the mold. A tapered sidewall (for example, wider at the top than at the bottom) in the mold cavity helps promote easy withdrawal. During manufacturing, the cavities 2367 are filled with liquid beverage product, and placed in the cold side 2364 for a predetermined residence time. Optionally a handle or probe 2352b may be placed in the liquid beverage product and may add additional cooling power to the process. After the predetermined residence time, the tread 2366 is moved to the warm side 2362 to slightly melt the outside layer of the preform 2351. Thereafter as shown in FIG. 23B, the handle 2352 may be grasped and used to remove the preform 2351 from the tread 2366.

As shown in FIGS. 23A-23F, item 2352 is a handle or probe that may be used throughout the phases of unloading the preform from the mold, transporting it to where pods have been pre-positioned, and inserting the preform into the pods. This handle should not remain with the preform 2351 for use by the consumer. FIG. 23B illustrates a point in time when the four preforms 2351, previously held in the “tread” immersed in warm bath 2362, have been withdrawn. The removal may be performed, for example, with grippers or other known mechanisms for grasping and manipulating the position of a handle. FIG. 23C illustrates a point in time when these four preforms have been further transported to a location somewhat removed from process tank 2360. This distance may be a few inches or several feet or more, but necessarily occurs quickly to minimize further melting of the preform outside of a chilled mold and is intended to position the preforms adjacent to the pods in which they will be inserted.

FIG. 23D illustrates one embodiment for how preform 2351, supported by a handle 2352, may be positioned adjacent to a pod 103. FIG. 23E similarly illustrates one embodiment for the placement of preform 2351 (obscured by pod 103) and handle 2352 in the pod 103. FIG. 23F illustrates one embodiment after the handle 2352 has been withdrawn. As shown in FIG. 23F, a hole 2354 remains resulting from the handle 2352. This may, for example, form the preform 1504 as shown in FIG. 15, or preforms shown with holes in one side.

Referring again to FIGS. 23D-23F, in some embodiments, a preform shape 2351 can be made using a refrigerated probe or handle 2352) with a diameter equal to the desired inside diameter 2354 of the preform and a mold to control the outside shape. According to some embodiments, the probe 2352 freezes in place within the preform 2351 as the preform is frozen within the mold cavity, such as cavity 2367 in FIGS. 23A-23F.

In some embodiments, a probe 2352 can assist in the removal of thermal energy from the liquid extract to assist the brine or other refrigerant mentioned above in solidifying the preform. For example, the probe 2352 could be a heat pipe, a device that rapidly transports thermal energy from one end, e.g., the immersed end 2372, of the heat pipe to second end, e.g., an end 2374, which is exposed above the pod where the heat pipe 2352 can be gripped by, for example, a chilled or refrigerated clamp. In so doing, the heat pipe 2352 causes the preform 2351 to also freeze from the inside out in addition to any cooling provided on the outside edge of the preform 2351, for example, from the cold bath 2364 of FIGS. 23A-23C. After freezing, the preform 2351 and the joined heat pipe 2352 as shown in FIG. 23E, can be positioned over the pod 100 preparatory to insertion. Once in the pod 100, as shown in FIG. 23E, the probe 2352 can be heated to promote slight thawing of the preform 2351 at the probe/preform interface allowing for easier removal of the probe. This heating can occur, for example, by causing the refrigeration process to be briefly reversed. Alternatively, if a heat pipe 2352 is used, the clamping mechanism holding the top of the heat pipe 2374 can be heated so thermal energy is transported from the clamp to the immersed end of the heat pipe. In some embodiments, molding of each preform 2351 occurs so the outer surface of the preform closely conforms to the tapered sidewalls 102 of the pod ID as shown in FIG. 23F. In some embodiments, as noted above, alternative shapes designed to intentionally create flow paths for diluting liquids around the preform can be formed into the preform 2351. For example, as shown in FIG. 23F, the preform 2351 may be formed to have flow paths 2357. According to some embodiments, the preform 2351 is molded such that it does not contact a portion or the entirety of bottom 103 so that the entry path for a bottom needle is unobstructed, as discussed throughout the present disclosure.

In some embodiments, the preform is partially or totally frozen using a coolant such as a brine solution applied to the outside of the mold, as discussed with reference to FIGS. 23A-23C. The mold may be subsequently heated in a warm bath to allow the preform to dislodge from the mold easier so the preform can be moved to and positioned within the pod. In some embodiments, the interior surfaces of the mold may be coated with a thin layer of ice to facilitate the dislodging of the frozen liquid contents. In some embodiments, the frozen preform may be moved and positioned within the interior dimensions of the pod using a mechanically operated claw, mechanically operated suction cup, gravity, or by using a probe that was inserted into the frozen liquid contents before freezing.

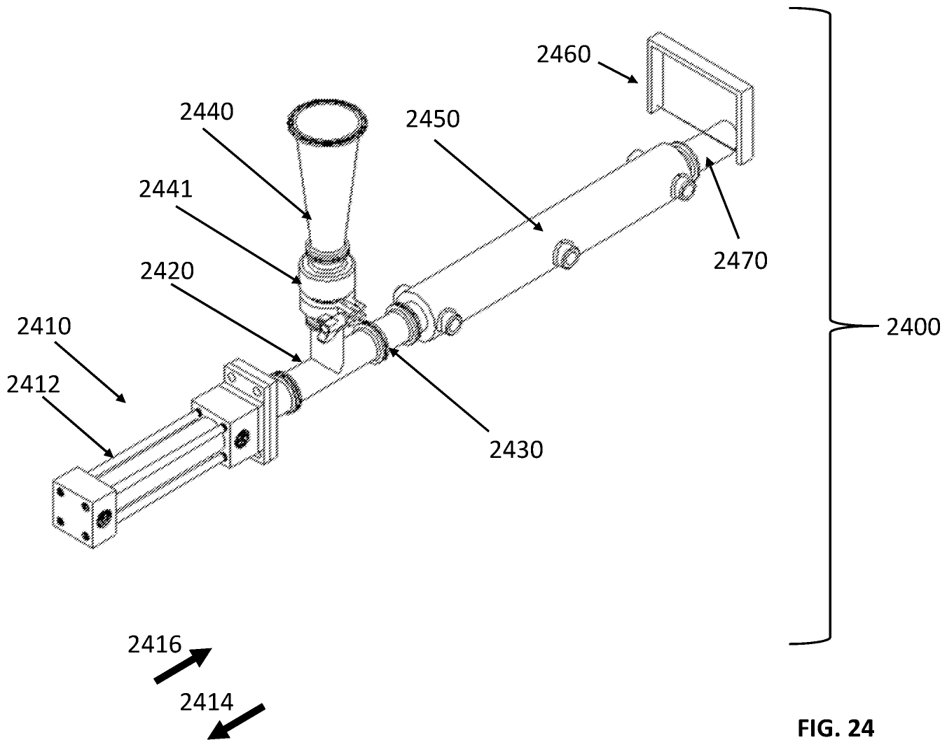

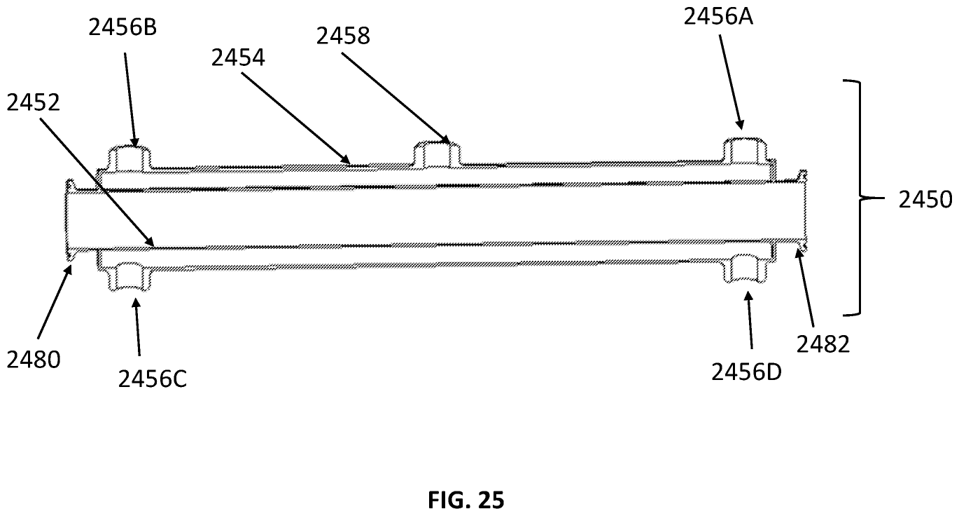

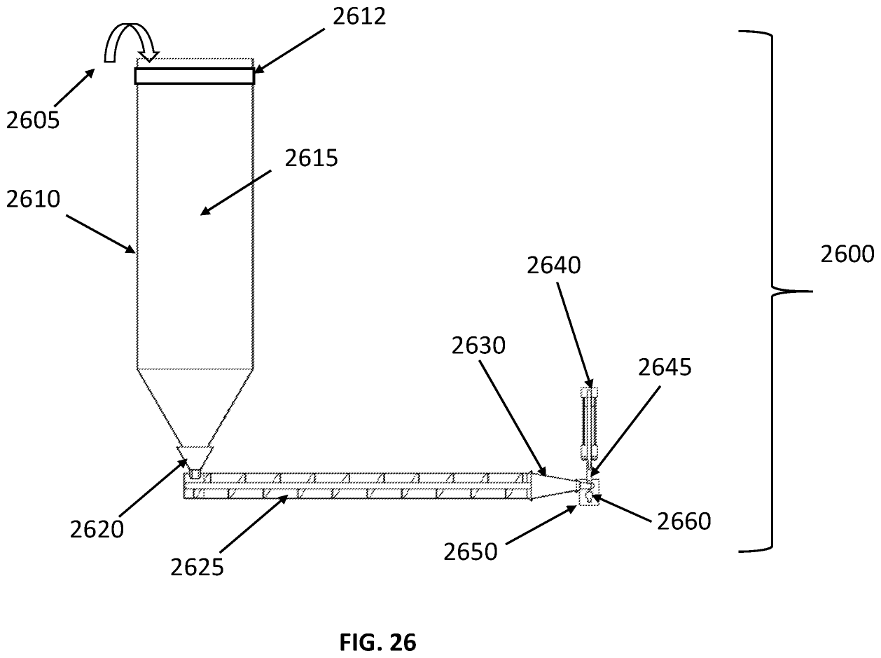

Referring to FIGS. 24-25, in some embodiments, the preform shapes identified above, such as, but not limited to those shown in FIGS. 13, 16, and 17, may be fabricated by system 2400. System 2400 may include a feed funnel 2440 for introducing extract, such as a liquid beverage product. At the bottom of funnel 2440 is a check valve 2441 to prevent extract being pushed back out the funnel during system operation. Extract is pulled into the extruder tee 2400 when hydraulic or pneumatic cylinder 2410 withdraws its ram (not shown) in backward direction 2414, creating a vacuum in tee 2420. Once the ram is fully retracted and tee 2420 is filled with extract to a desired fill line or in its entirety, the ram can be pushed in forward direction 2416, driving extract through check valve 2430 and into chilled extrusion tube 2450. Tube 2450 is sized in length to provide sufficient dwell time for the liquid extract to freeze throughout prior to exiting the tube as a solid 2470. Thereafter, some cutting mechanism like hot wire cutter 2460 can slice preforms to the preferred length for insertion into pods. According to some embodiments, the hot wire cutter 2460 is replaced with another cutting implement, such as a knife, blade, or other cutting implements known in the art.

According to some embodiments, the system 2400 could be replaced with a higher capacity system utilizing a high-pressure pump in lieu of cylinder 2410 to achieve a continuous operation. Under this circumstance, funnel 2440 would be replaced by a pipe connection to the pump inlet and check valve 2430 could be eliminated. According to some embodiments, a more complex cutoff tool could be provided, such as, but not limited to a “flying blade” that could account for no stoppage in the flow of a solid extrusion emerging from the chilled tube or die 2450. In some embodiments, a “flying blade” or wire is not used and the cutoff ends of a moving solid extrusion 2470 are intentionally cut at an angle relative to the direction of movement. This angle of cut creates “standoff” features similar to that achieved in the frozen slugs of FIGS. 6, 19 and 22. According to another embodiment, the tube and die can be different elements of different sizes. The die may have a smaller aperture than the tube by itself

Referring to FIG. 25, in some embodiments, a chilled extrusion tube 2450 could made using, for example, but not limited to a piece of sanitary tubing 2452 with Tri-clamp fittings 2480, 2482 on each end, a jacket 2454, various ports to the jacket for chilling 2456A-2456D, and a temperature sensor port 2458. In some embodiments, the process of operating extrusion tube 2450 could be performed in a batch mode during which tube 2450 is filled, the entire content is frozen solid using cooling liquid or gas through ports 2456A-2456D, and then pushed out as a long cylinder prior to or concurrently with being cut to size. In some embodiments, cold glycol liquid could be flowed through one pair of ports 2456A and 2456C (one on each end of the tube) until freezing is complete, followed by a warm glycol fluid flowed through a second pair of ports 2456B and 2456D to thaw an interfacial layer between frozen preform 2470 and the inner wall of tube 2452 to help “lubricate” the removal of the extrusion and minimize stresses on the preform 2470 and/or components of the system 2400.

As is well known in the art of extrusion, the range of shapes possible is almost unlimited. The shapes may beneficially be designed as discussed throughout the present disclosure so as to provide for a headspace at the top and bottom of a receptacle/pod, and to create a flow path between fluid entry and exit points formed, for example, by a needle. The process may involve extruding a frozen shape by conversion of a fluid or partially solidified material to a “frozen” solid of the desired geometry.

In some embodiments, the liquid extract is first frozen into flake ice or nugget ice or some similar small ice format readily known to the ice manufacturing industry or into spheres formed by passing drops of extract through a cryogenic gas or liquid medium, with care to keep the liquid extract homogenized (no segregation of dissolved solids or suspended fine particles). Thereafter, the ice particles are separated into “shots” of the correct final preform weight, funneled into a mold cavity, and mechanically compressed into any of the shapes described above for FIGS. 1-19 or other shapes generally envisioned by this specification. These molded shapes can then be ejected and, as is well known in the art for processes such as injection molding, deposited into a pod. These molded shapes could be made in a compliant mold that distorts to allow the shape to exit the mold. The mold may also be agitated and/or heated in order to cause the shape to exit.

As an illustration of this concept, and referring to FIG. 26, liquid extract 2605 is introduced into the top of a sphere forming column 2610. Using a sieve 2612 to break a solid stream of extract 2605 into droplets, these droplets fall through a reduced-oxygen cryogenic atmosphere 2615 (for example an atmosphere created over a pool of liquid nitrogen). As these droplets fall through atmosphere 2615, they freeze into solid spheres and are collected in hopper 2620. Thereafter the frozen spheres are transported using a refrigerated/jacketed auger system 2625 to a funnel 2630 and pushed into injection split mold 2650. Metering may occur volumetrically as a fixed volume of spheres can be displaced into the mold entry sprue under auger pressure. Hydraulic cylinder 2640 is then activated, forcing ram 2645 to displace frozen spheres into mold cavity 2660. Mold 2650 is kept cold to further chill the preform. After a timed hold cycle, split mold 2650 is opened and a preformed slug drops out or is ejected using pins or other known removal techniques.

As noted above, concepts shown in FIGS. 2-19 are exemplary in nature and intended to illustrate means of creating the liquid frozen contents slug alternative to the method illustrated in FIG. 1. Whether formed in place, with or without fixturing or dynamic effects, or performed by any of a variety of methods, the intent in all cases is to provide a more natural or more easily formed flow path from entrance to exit needles while still providing needed interaction between the melting/diluting liquid and the frozen slug.

As shown throughout the figures, the needle positions for both entrance and exit needles reflect those typical of brewers on the market designed to work with KEURIG®-like pods. The position and configuration can be modified to other pods as well to avoid entry and exit interference. More specifically, the entrance needle is generally centered on the lid and the exit needle is generally near the outer periphery of the bottom of the pod/receptacle. These locations, however, are not limiting, and different brewers with different needle locations are contemplated. It will be recognized that the relative suitability of a given profile shape may be changed and produced in accordance with the methods and techniques discussed in the present disclosure to accommodate different needle locations.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A method for manufacturing a frozen liquid beverage product comprising the steps of:
positioning in a first orientation a receptacle having an end layer, a side wall surrounding the end layer, and an open top opposite the end layer, the end layer and side wall defining a receptacle volume;
disposing a liquid beverage product in the receptacle, the liquid beverage product occupying less than the entire receptacle volume;
freezing the liquid beverage product to form a frozen liquid beverage product conforming to a first portion of the end layer and a first portion of the side wall;
thawing at least a portion of the frozen liquid beverage product to release the frozen liquid beverage product from the first portion of the end layer and the first portion of the side wall;
repositioning the receptacle into a second orientation different from the first orientation; and
refreezing the at least a portion of the frozen liquid beverage product such that the refrozen liquid beverage product contacts at least one of:
a second portion of the end layer different from the first portion of the end layer, and
a second portion of the sidewall different from the first portion of the sidewall.

2. The method of claim 1, further comprising sealing the open top with a top layer before the repositioning the receptacle, wherein the repositioning the receptacle and the refreezing forms the refrozen liquid beverage product with a shape and position that, in part, defines a headspace between the refrozen liquid beverage product and a center of the top layer and a headspace between the refrozen liquid beverage product and the end layer.

3. The method of claim 1, further comprising sealing the open top with a top layer before the repositioning the receptacle, wherein the repositioning the receptacle and the refreezing forms the refrozen liquid beverage product with a shape and position that, in part, defines at least one flow path between a center of the top layer and a point on the end layer.

4. The method of claim 1, wherein the freezing the liquid beverage product to form a frozen liquid beverage product conforming to the first portion of the end layer and the first portion of the side wall comprises positioning the receptacle in the first orientation such that the liquid surface is not parallel to the end layer.

5. The method of claim 1, wherein the refreezing the at least a portion of the frozen liquid beverage product comprises adhering the refrozen liquid beverage product to at least one of:
the second portion of the end layer different from the first portion of the end layer, and
the second portion of the sidewall different from the first portion of the sidewall.

6. A method for manufacturing a frozen liquid beverage product comprising the steps of:
providing a receptacle having an end layer, a side wall surrounding the end layer, and an open top opposite the end layer, the end layer and side wall defining a receptacle volume;
disposing a liquid beverage product in the receptacle, the liquid beverage product occupying less than the entire receptacle volume, and the liquid beverage product defining a liquid surface;
positioning the receptacle in an orientation such that the liquid surface is not parallel to the end layer; and
freezing the liquid beverage product to form a frozen liquid beverage product conforming to at least a first portion of the side wall or a first portion of the end layer.

7. The method of claim 6, further comprising sealing the open top with a top layer, wherein the positioning the receptacle and the freezing the liquid beverage product forms the frozen liquid beverage product with a shape and position that, in part, defines a headspace between the frozen liquid beverage product and a center of the top layer and a headspace between the refrozen liquid beverage product and the end layer.

8. The method of claim 7, further comprising sealing the open top with a top layer, wherein the positioning the receptacle and the freezing the liquid beverage product forms the frozen liquid beverage product with a shape and position that, in part, defines a frozen liquid surface of the frozen liquid beverage product opposite the top layer that is not parallel with the top layer.

9. The method of claim 6, further comprising sealing the open top with a top layer, wherein the positioning the receptacle and the freezing forms the frozen liquid beverage product with a shape and position that, in part, defines at least one flow path between a center of the top layer and a point on the end layer.

10. The method of claim 6, the freezing the liquid beverage product occurring during the positioning the receptacle, the positioning the receptacle comprising rotating the receptacle.

11. A method for manufacturing a frozen liquid beverage product comprising the steps of:
cooling an elongate die having a substantially continuous cross-section in an extrusion direction from an entrance end to an exit end;
passing liquid beverage product from the entrance end along the extrusion direction to the exit end such that the liquid beverage product becomes a frozen liquid beverage product;
trimming a portion of the frozen liquid beverage product extending beyond the exit end to form a frozen liquid beverage product preform; and
positioning the frozen liquid beverage product preform into a receptacle, the receptacle having an end layer, a side wall surrounding the end layer, and an open top opposite the end layer, the end layer and side wall defining a receptacle volume;
sealing the open top with a top layer, wherein the passing, trimming, and positioning forms the frozen liquid beverage product preform with a shape and position that, in part, defines at least one of:
a headspace between the frozen liquid beverage product preform and a center of the top layer,
a headspace between the frozen liquid beverage product preform and the end layer, and
at least one flow path between a center of the top layer and a point on the end layer.

12. The method of claim 11, wherein the trimming the portion of the frozen liquid beverage product extending beyond the exit end comprises trimming at an angle that is not perpendicular to the extrusion direction.

13. A method for manufacturing a frozen liquid beverage product comprising the steps of:
positioning a probe tip into liquid beverage product;
freezing at least a portion of the liquid beverage product around the probe tip;
providing a receptacle, the receptacle having an end layer, a side wall surrounding the end layer, and an open top opposite the end layer, the end layer and side wall defining a receptacle volume;
transferring, with the probe, the frozen portion of the liquid beverage product to the receptacle;
positioning the frozen portion of the liquid beverage product within the receptacle volume; and
sealing the open top with a top layer, wherein the freezing and the positioning the frozen portion of the liquid beverage product forms the frozen liquid beverage product with a shape and position that, in part, defines at least one of:
a headspace between the frozen liquid beverage product and a center of the top layer,
a headspace between the frozen liquid beverage product and the end layer, and
at least one flow path between a center of the top layer and a point on the end layer.

14. The method of claim 13, wherein the transferring and the positioning are performed concurrently.

15. The method of claim 13, wherein the positioning is performed after the sealing the open top.

16. The method of claim 13, wherein the positioning the probe tip into the liquid beverage product comprises positioning the probe tip into a mold containing liquid beverage product.

17. The method of claim 13, wherein the positioning the probe tip into the liquid beverage product comprises positioning the probe tip into a liquid beverage product reservoir containing liquid beverage product.

18. The method of claim 17, wherein freezing at least the portion of the liquid beverage product around the probe tip comprises freezing less than the entire amount of liquid beverage product in the liquid beverage product reservoir.
